(19) United States
(12) Patent Application Publication
(10) Pub. No.: US 2006/0231301 A1
(43) Pub. Date: Oct. 19, 2006

(54) Coast control for motorized pallet truck

(76) Inventors: Timothy L. Rose, Winterville, NC (US); Matthew K. Hoffman, Greenville, NC (US)

Correspondence Address: MARGER JOHNSON & MCCOLLOM, P.C., 210 SW MORRISON STREET, SUITE 400, PORTLAND, OR, 97204, US

(21) Appl. No.: 11/372,638

(22) Filed: Mar. 10, 2006

Related U.S. Application Data
(63) Continuation-in-part of application No. 11/109,900, filed on Apr. 19, 2005.
(63) Continuation-in-part of application No. 11/110,095, filed on Apr. 19, 2005.

(51) Int. Cl. B62D 51/04

(52) U.S. Cl. 180/19.1

(57) ABSTRACT

A system for controlling a motorized vehicle, comprising: a controller configured to activate a pick state for a motorized vehicle only while the motorized vehicle is in a low speed travel mode and a control arm is located in a non-braking position, the controller further configured to override a dead-man brake mechanism and automatically actuate a traction motor that drives the motorized vehicle within the low speed travel mode while the pick state is activated.

This application claims priority and is a Continuation In Part (CIP) of U.S. patent application Ser. No. 11/109,900 filed on Apr. 19, 2005 and U.S. patent application Ser. No. 11/110,095 also filed on Apr. 19, 2005, all of which are assigned in common to NMHG Oregon, Inc. U.S. patent applications Ser. Nos. 11/109,900 and 11/110,095 are herein incorporated by reference.

### BACKGROUND

An industrial pallet truck is utilized to lift and transport loads between locations. The operator of the pallet truck may be required to move loads repeatedly on and off of the pallet truck within a very short period of time, and is often required to move specific inventory from various locations in what is termed “picking.” During this practice, it is desirable that the operator can leave the pallet truck and pick a load while the pallet truck continues to move in the direction of the next load. In this way, the lifting and transporting of loads is most efficient. To avoid inadvertent vehicle travel, pallet trucks have a dead-man mechanism that engage a vehicle brake in the event that the operator leaves the pallet truck and releases the control arm. It is not practical for the operator to continue to hold the control arm in a non-braking position as he leaves the pallet truck and moves to the next pick location, therefore it is desirable to have a coast control system which retards, or overrides the dead-man brake mechanism, to allow the pallet truck to coast. The coast control system typically holds the control arm in a fixed or variable position between vertical and horizontal, such that the vehicle brake does not become engaged, and the pallet truck is allowed to coast to a stop in a controlled manner.

Coast control systems are well known in the art, whereby the pallet truck may include a means for holding the control arm in a non-braking position during a picking operation. A problem associated with designs known in the art includes mechanisms which are subject to accelerated breakdown and wear due to environmental conditions. For example, some designs provide for exposed mechanisms which after a period of time may not function correctly in certain environments. These environments may include locations having low temperatures, high humidity or where the air contains high particulate counts. Other designs include complex or hard to access mechanisms which may be difficult to replace or repair.

The present invention addresses these and other problems associated with the prior art.

### SUMMARY OF THE INVENTION

The present invention provides for an improved apparatus, system and method to control the operability of a motorized vehicle such as an industrial pallet truck.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a perspective view of a typical pallet truck in which the present invention may be made operable;

FIG. 2 is a perspective view of the steer control handle;

FIG. 3 is a perspective view of the control panel located on the support bar;

FIG. 4A is a perspective view of a control arm and coast control system of the pallet truck;

FIG. 4B is a top view of the control arm and coast control system shown in FIG. 4A;

FIG. 4C is a cross sectional view of the control arm and coast control system identified as section D-D in FIG. 4B;

FIG. 4D is an enlarged cross sectional view of the coast control system shown in FIG. 4C;

FIG. 4E is a cross sectional view of the coast control system identified as section E-E in FIG. 4D;

FIG. 5 is a schematic diagram depicting the hydraulic functionality of one embodiment of the coast control system;

FIG. 6 is a side view of the control arm mounted to a pallet truck shown in partial view, depicting three different ranges of motion;

FIG. 7 is a schematic diagram representing the coast control system and a motor controller;

FIG. 8 is a flow diagram showing the logical flow of the pick state of the motorized vehicle; and

FIG. 9 is a perspective view of an alternate embodiment of the invention, with a coast control button located on the operator platform.

### DETAILED DESCRIPTION

A detailed description of the invention is now provided, making reference to the accompanying figures.

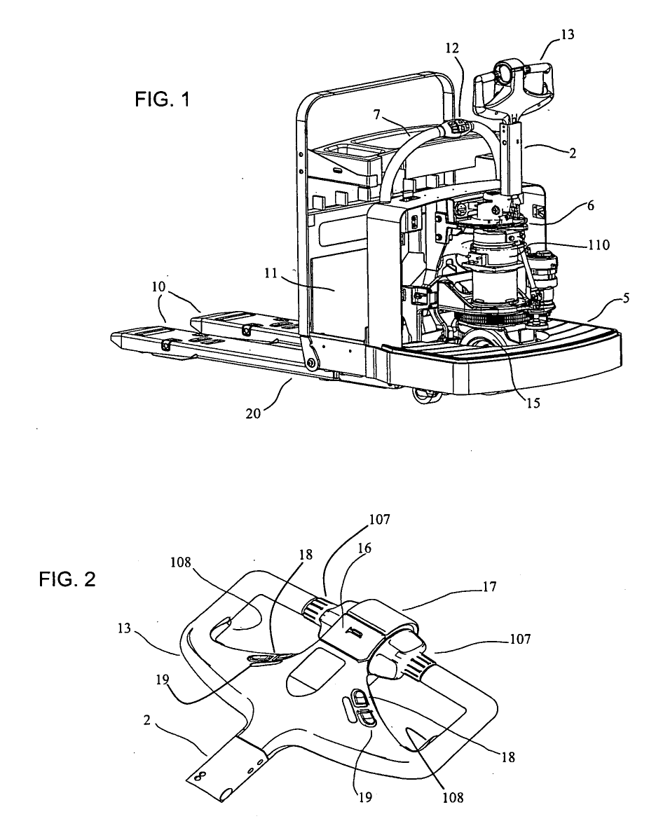

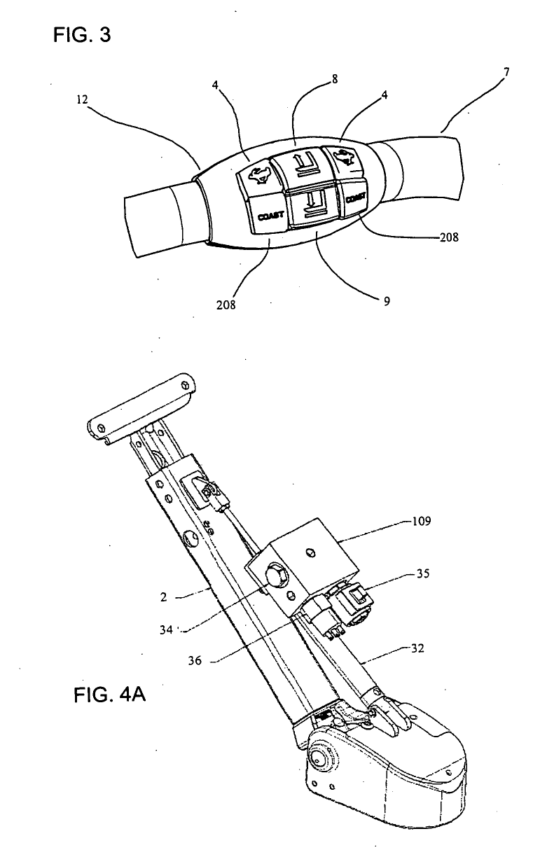

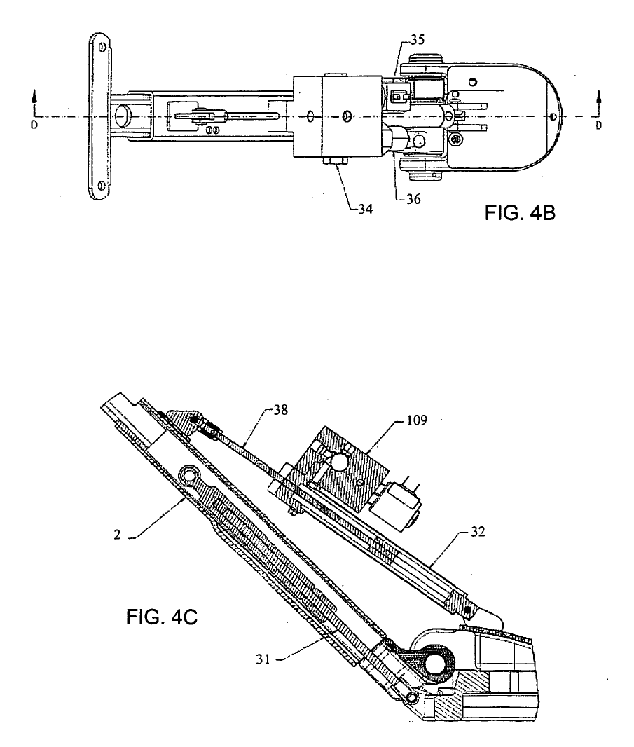

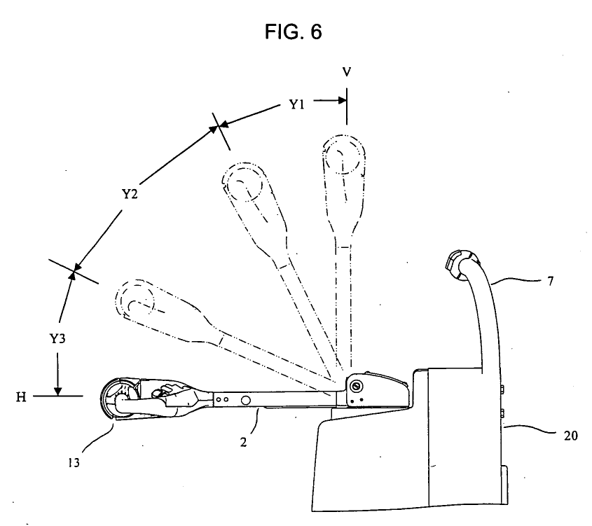

FIG. 1 shows a typical pallet truck 20 which may be used with the present invention. The pallet truck 20 includes an operator platform 5, by which the operator (not shown) may stand on the pallet truck 20. From the operator platform 5, the operator is able to reach the support bar 7 and steer control handle 13. The support bar 7 has at its center point a control panel 12, which is shown in more detail in FIG. 3. The pallet truck 20 may be powered by a traction motor 110 which is energized by a battery 111 (FIG. 6) located in the battery compartment 11. The steer control handle 13, which is shown in greater detail in FIG. 2 includes a horn button 16, an emergency reverse button 17, two lift buttons 18, and two lower buttons 19. The lift buttons 18 and lower buttons 19 lift and lower, respectively, the forks 11 upon which a load is placed. Two sets of lift buttons 18 and lower buttons 19 are provided to faciliate operation by either a left or right handed operator The emergency reverse button 17 reverses the direction of the traction motor 110. The steer control handle 13 is attached by means of a steer control arm 2 to a steer control unit 6 which controls the direction of a drive wheel 15, which is located directly under the traction motor 1 10, and controls the direction of travel of the pallet truck 20.

Pick buttons 108 are provided on either side of the steer control handle 13, which may be used to activate a pick state of a coast control system 109 (FIG. 6). The pick button 108 may be pressed to actuate the traction motor 110 within a low speed travel mode, while the pallet truck 20 remains in the pick state. In one embodiment, the coast control system 109 and the traction motor 110 are both engaged at the first instance of pressing one of the pick buttons, in order to most efficiently initiate the picking process. The pallet truck 20 may operate in a low speed travel mode until the operator takes definite action to activate a high speed travel mode, for example, or a vehicle brake switch 101 (FIG. 6) is activated. In one embodiment, the pick button 108 is disabled in the high speed travel mode, such that the pallet truck 20 may only be operated in the pick state while the pallet truck 20 is in the low speed travel mode.

The steer control handle 13 has two symmetrically located pick buttons 108 and two symmetrically located variable throttles 107. When the operator is on the operator platform 5 or is walking alongside of the pallet truck 20, the operator may advantageously activate one of the pick buttons 108 or throttles 107 with the same hand that is holding and controlling the steer control handle 13. The pallet truck 20 may be accelerated by means of a traction motor 110 that may be operated in either the low speed travel mode or the high speed travel mode. In either low speed or high speed travel modes, the traction motor 110 may be actuated by means of one of the throttles 107. The rate of acceleration and maximum travel speeds obtained in the low and high speed travel modes are determined according to the current limiting characteristics of the low and high speed travel circuits, respectively. For example, the low speed travel mode provides for a maximum travel speed of approximately 3.5 miles per hour. Activation of the throttle 107 causes the traction motor 110 to move in the forward or reverse direction in the low speed travel mode depending on the command sent by the throttle 107 to the traction motor 110. In the example pallet truck 20 shown in FIG. 1 and FIG. 2, the throttle 107 is a butterfly type design which may be rotated forward, away from the operator, to cause the pallet truck 20 to move in the reverse direction, or may be rotated backward, towards the operator, to cause the pallet truck 20 to move in the forward direction, similar to a conventional motorcycle throttle. Other types of throttle 107 may be used, such as twist grips, buttons, toggles, and pedals, without affecting the function of the present invention. Similarly, different positions or more instances of the pick button 108 do not affect the function of the present invention.

With the throttle 107 positioned in the forward or reverse direction, the operator may simultaneously or sequentially press either of the two symmetrically located high speed buttons 4, located on the control panel 12 (FIG. 3). The operator may then continue to activate the throttle 107 in the high speed mode, whereby the pallet truck 20 is able to travel at a higher maximum speed, for example when the operator needs to move a greater distance between picking loads. If the throttle 107 is released or placed in a neutral position, the pallet truck 20 coasts to a stop, or is caused to brake depending on the position of the steer control arm 2. In one embodiment, subsequent activation of the throttle 107 causes the pallet truck 20 to travel in the low speed mode until and unless the high speed button 4 is again activated.

The control panel 12 shown in FIG. 3 may be equipped with two symmetrically located auxiliary pick buttons 208, an auxiliary lift button 8 and an auxiliary lower button 9, which function to lift and lower, respectively, the forks 10. Auxiliary pick buttons 208, auxiliary lift button 8, and auxiliary lower button 9, function the same as pick buttons 108, lift buttons 18, and lower buttons 19, respectively. Where this written description references any of the buttons located on the steer control handle 13, the associated auxiliary button on the control panel 12 is assumed to provide the same functionality and achieve the same result as if it had instead been pressed by the operator.

An alternate embodiment of the invention provides for the auxiliary pick buttons 208 functioning purely to activate the coast control system 109, and not actuate the traction motor 110 on the initial or any subsequent activation of the auxiliary pick buttons 208. Actuation of the traction motor 1 10 may be accomplished by activating the pick buttons 108 after the coast control system 109 has first been activated.

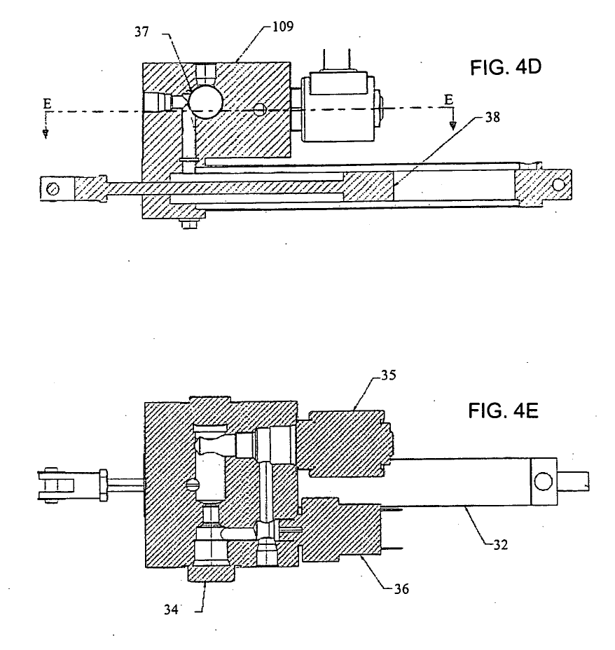

The control arm 2 and coast control system 109 are shown in FIG. 4A and FIG. 4B, as separated from the pallet truck 20 for clarity. Visible components of the coast control system include an actuation cylinder 32, a check valve 34, a solenoid valve 35, and a pressure switch 36. A cross-sectional view of the control arm 2 and coast control system 109 is shown in FIG. 4C, and is further identified as section D-D in FIG. 4B. FIG. 4C shows that a return spring 31 may be provided in the control arm. Actuation cylinder 32 may include an internal rod 38 that slides in and out of the cylinder 32 according to a vertical pivoting movement of the control arm 2. By holding the rod 38 substantially rigid with respect to the actuation cylinder 32, the control arm 2 may be locked in one of an infinite number of positions as determined by the operator. The rod 38 may be held rigid by applying a hydraulic, pneumatic, or mechanical force, for example, as further described below.

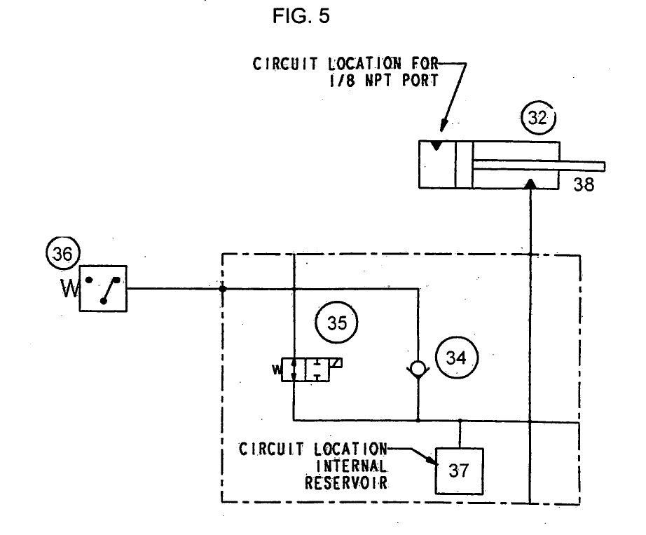

FIG. 4D provides an enlarged view of the coast control system 109 including the same cross section shown in FIG. 4C. In this view, the rod 38 and a hydraulic reservoir 37 can be clearly seen. Additionally, FIG. 4E provides a different cross-sectional view identified by section E-E, although it is understood that the section E-E is taken with respect to the entire coast control system 109, rather than the cross-sectional view shown by section D-D in FIG. 4D. FIG. 4E therefore provides a top view of the internal components of the coast control system 109. The interaction of these components is further illustrated with respect to the hydraulic schematic shown in FIG. 5.

With the pallet truck 20 in a powered-down state, return spring 31 causes the control arm 2 to remain in a vertical position, thereby activating a vehicle brake switch 101. The return spring 31 is shown as being connected internally to the control arm 2, however it could similarly be attached externally. The return spring 31 retains the control arm 2 in the vertical position in the powered-down and powered-up states unless moved to a non-vertical position by the operator. In one embodiment, with the control arm 2 of the pallet truck 20 in a braking position, the low and high speed travel circuits may not be energized and therefore the traction motor 110 may not be actuated, even after the key switch 100 has been turned on and the pallet truck 20 has been powered-on. In another embodiment a dead-man brake override, or “creep speed” button, may be pressed which allows actuation of the traction motor 110 even when the control arm 2 is in a braking position. Actuation of the traction motor 110 according to the brake override button may be restricted to a reduced maximum travel speed of the pallet truck 20.

With the pallet truck 20 in a powered-on state, and the control arm 2 lowered to a non-braking position, the pallet truck 20 automatically enters the low speed travel mode. In this mode, the operator may operate the pallet truck 20 when riding on, when walking alongside, or walking behind, the pallet truck 20. If the operator releases the control arm 2, the return spring 31 causes the control arm 2 to return to a vertical position and activate the vehicle brake switch 101, thereby causing the pallet truck 20 to stop.

The dead-man brake mechanism functions when the operator ceases to hold the control arm 2 in a non vertical position. In this case, the return spring 31 normally applies a force to move the control arm 2 to a vertical, braking position, which in turn activates the vehicle brake switch 101. However, the return spring 31 force may be overcome by the operator holding the steer control handle 13 in a lowered position.

When the coast control system 109 is activated, the control arm 2 is locked in the position intermediate between pivot ranges Y1 and Y3 shown in FIG. 6. As a result, the control arm 2 remains in a non-braking position even if the operator releases both the pick button 108 and the steering handle 13, and the pallet truck 20 is allowed to coast to a stop if no further operator intervention occurs. The operator can overcome the force applied by the actuation cylinder 32 by applying pressure to the steer control handle 13 in either an upward or downward motion in order to move the control arm 2 to a braking position, for example. With the control arm 2 in a braking position this activates the vehicle brake switch 101 which then causes a braking force to be applied to the pallet truck 20.

An embodiment of the invention is now described making reference to FIGS. 5, 6 and 7. Activation of the pick button 108 causes the pick switch 103 to signal a motor controller 105 and thereby engage the coast control system 109. The solenoid valve 35 inhibits the flow of hydraulic fluid through the actuation cylinder 32, thereby building pressure and exerting a force on the control arm 2 in the user selected position. The pressure in the actuation cylinder 32 is enough to overcome the force applied by the control arm return spring 31, and instead maintain the control arm 2 in a user selected position.

By applying an upward force to the steer control arm 2 that is locked in a range Y2, a pressure within the actuation cylinder 32 increases until a predetermined pressure causes the pressure switch 36 to open and actuate the solenoid valve 35. The solenoid valve 35 releases the pressure from the actuation cylinder 32 and allows hydraulic fluid to flow back to the reservoir 37. This hydro-mechanically releases the coast control system 109 and allows the steer control arm 2 to be moved from range Y2 to the Y1 braking position according to the upward force. The brake switch 101 is opened when the steer control arm is in range Y1. As previously disclosed, this upward force may be applied either by the operator or by the return spring 31. The motor controller 105 is disabled when the brake switch 101 is opened.

Similarly, when a downward force is applied to the steer control arm 2 that is locked in a range Y2, a pressure within the actuation cylinder 32 increases until a predetermined pressure causes the pressure switch 36 to open and actuate the solenoid valve 35. The solenoid valve 35 releases the pressure from the actuation cylinder 32 and allows hydraulic fluid to flow back to the reservoir 37. This hydro-mechanically releases the coast control system 109 and allows the steer control arm 2 to be moved from range Y2 to the Y3 braking position according to the downward force. The brake switch 101 is opened when the steer control arm is in range Y3, thereby disabling the motor controller 105. The downward force may be applied by the operator.

The coast control system 109 provides for retaining the control arm 2 in an operator selected position between vertical and horizontal, for example. In an alternative embodiment, a mechanical or pneumatic force may be applied to the actuation cylinder 32 that would function to lock the control arm 2 in a user selected position. For example, a pneumatic force could be directed into the actuation cylinder 32 that would lock the rod 38 in a rigid position. Similarly, a mechanical force such as a gear or locking device could hold the rod 38 rigid with respect to the actuation cylinder 32. Other types of actuating cylinders having rods that are known in the art are claimed herein.

With the pallet truck 20 operating in the low speed travel mode, the operator is able to activate the pick state, or walking state, of the pallet truck 20 by activating a pick button 108. The pick button 108, or other type of switch, may be located anywhere on the truck, including the control arm handle 13, the operator platform 5, or on the support bar 7, for example. With the pick state activated by means of a pick button 108 located on the control arm handle 13, the coast control system 109 of the pallet truck is activated which causes the control arm 2 to remain in a non-braking position. This prevents the vehicle brake switch 101 from being activated. As a result, the pallet truck 20 is allowed to coast to a stop after the traction motor 110 is de-actuated.

Activation of the pick button 108 causes the pallet truck 20 to move in the forward direction, towards the forks 10, up to the maximum allowable travel speed in the low speed travel mode. Activation of the pick button 108 also overrides the return spring 31. The pallet truck 20 continues being accelerated in the forward direction so long as the pick button 108 is being depressed, up to a maximum travel speed. When the operator releases the pick button 108, the pallet truck 20 coasts to a stop regardless of whether or not the operator maintains physical contact with the pallet truck 20 or control arm 2, thereby allowing the operator to walk alongside, or ahead of the pallet truck 20 to pick the next load. While the pallet truck 20 is in the pick state, the operator is able to repeatedly accelerate the pallet truck 20 within the low speed travel range by either reactivating the pick button 108, or by holding open the throttle 107.

The pallet truck 20 remains in the pick state until the vehicle brake switch 101 is activated, the high speed travel button 4 is activated, the battery 111 is disconnected, or the key switch 100 is turned off. The battery 111 may become disconnected from the electrical circuit by physical removal of connecting wiring or if the operator presses an emergency off button (not shown), and in either case the pallet truck 20 is no longer be operating in the pick state. If the operator manually forces the control arm 2 into either a vertical or horizontal position, the vehicle brake switch 101 is activated, the traction motor 108 is de-actuated as the low and high speed travel circuits are open, and the pallet truck 20 is longer operating in the pick state.

In a preferred embodiment, activation of the throttle 107, pick button 108, and the high speed button 4 is not effective with the control arm 2 in a braking position. The braking positions of the control arm 2 is specified by an approximate vertical position V and approximate horizontal position H as shown in FIG. 6. The term approximate as used in the preceding sentence, could be understood to provide a predetermined angle from the vertical or horizontal position, for example. The throttle 107, pick button 108, and the high speed button 4 may all be normally applied when the control arm is located in range Y2. As the control arm 2 approaches the vertical and horizontal braking positions, and is in the ranges of motion shown as Y1 and Y3, the level of performance of the traction motor 110 may be maintained at a lower value so as to avoid abrupt changes in acceleration of the pallet truck 20. These systems recognize that when the control arm 2 is in a near vertical position that the operator is likely preparing to brake the pallet truck 20, and requires more sensitive control for steering and acceleration at these lower speeds. By causing a reduction in the overall rate of acceleration of the pallet truck 20, the operator is able to control the speed of the pallet truck 20 in finer increments while using the same throttle 107 as at normal travel speeds. Similarly, one embodiment of this invention includes a high speed button 4 that is only functional in the range Y2, or instead that would provide for an intermediate vehicle acceleration rate less than the maximum high speed travel rate and greater than the low speed travel rate.

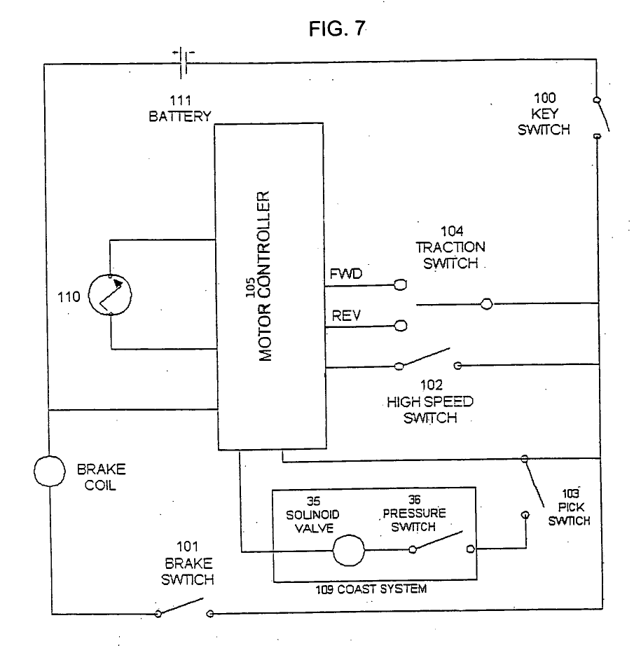

As previously indicated, FIG. 7 provides an illustrative circuit for the preferred embodiment of the invention. This circuit provides for various modes of travel, including low speed travel mode, high speed travel mode, coast control, and the pick state or walking state. With the pallet truck 20 in a powered-down state, all switches shown in FIG. 7, including 100, 101, 102, 103 and 104, are open, and the return spring 31 causes the control arm 2 to spring to a vertical position and activate the vehicle brake switch 101. When the pallet truck 20 is powered on, key switch 100 is closed, however the circuit is still not energized because the brake switch 101 remains open. When the vehicle brake switch 101 is activated it remains open. To close the brake switch 101, the operator is required to move the control arm 2 into a position between vertical and horizontal. Once both switches 100 and 101 are closed, the circuit is energized in a low speed travel mode. In the low speed travel mode, acceleration of the pallet truck 20 via a traction motor 110 may be accomplished by use of the variable throttle 107 which provides a limited predetermined rate of travel for the pallet truck 20 according to the regulation provided by the motor controller 105.

With the control arm 2 located in a non-braking position, the operator can activate the pick state by pressing the pick button 108. Pressing the pick button 108 closes the pick switch 103, thereby activating the coast control system 109. This energizes the motor controller 105 and actuates the traction motor 110 in the low speed travel mode as limited to a predetermined rate of travel for the pallet truck 10 according to the low speed travel range. The pick state is de-actuated when the pick button 108 is released and therefore the pick switch 103 is opened. The pallet truck 20 remains in the pick state until one of the following conditions occurs: the vehicle brake switch 101 is activated, the high speed switch 102 is activated, the battery 111 is disconnected, or the key switch 100 is turned off.

With the pick switch 103 closed, and the coast control system 109 activated, the control arm 2 is held in an operator selected position between vertical and horizontal by the coast control system 109 which thereby overrides the return spring 31. Therefore, when the operator releases the pick button 108, the traction motor 110 is de-actuated, however the coast control system 109 continues to override the return spring 31 thus allowing the pallet truck 20 to coast to a stop even when the operator is no longer holding the control arm 2 in a non-braking position. This allows the operator to leave the moving pallet truck 20, and walk alongside or ahead of the pallet truck 20 in order to pick the next load. This is considered the pick state or walking state of the pallet truck 20 operation. Pick state allows for continuous activation of the coast control system 109 and actuation of the traction motor 110 in the low speed travel mode, either by pressing the pick button 108 or engaging the throttle 107.

The operator may activate the high speed travel mode by simultaneously or sequentially engaging the throttle 107 and pressing the high speed button 4, which closes the high speed switch 102. After the throttle 107 is engaged, the high speed switch 102 remains closed until the throttle 107 is placed in neutral, the battery 111 is disconnected, or the key switch 100 is turned off. When the high speed switch 102 is closed, the pick button 108 is disabled, and both the pick switch 103 and the traction switch 104 become open. This results in the de-activation of the coast control system 109 if the pallet truck 20 was in the pick state prior to activation of the high speed travel mode.

Disconnecting the battery 111, opening the key switch 100, or opening the brake switch 101, causes all other switches in the circuit to become open, preventing engagement of the traction motor 110 in any of the travel modes or operating states discussed.

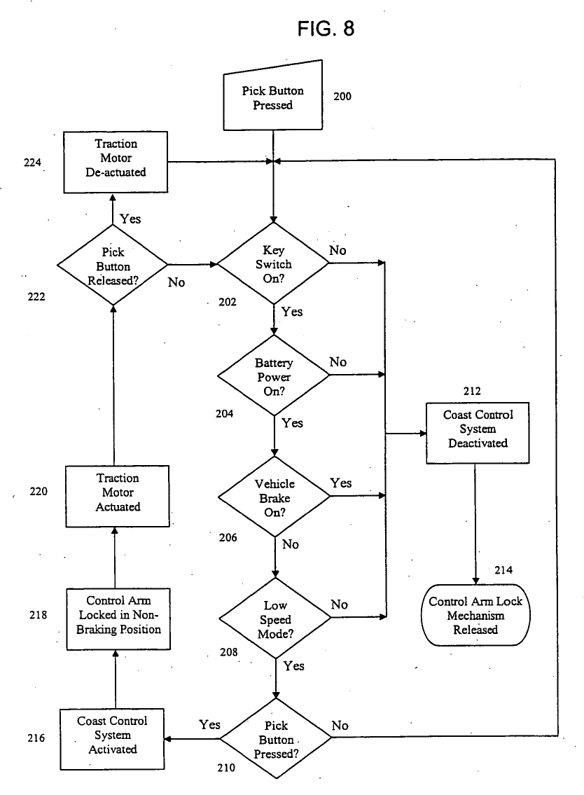

FIG. 8 shows an example flow diagram of the pick state logic of the pallet truck 20, as monitored by the motor controller 105, which may be an on-board processor in one embodiment. When the operator presses the pick button 108 at step 200, the pallet truck's motor controller 105 evaluates the state of the electrical and mechanical operating systems. Pressing the pick button 108 has no effect if any of the following prior conditions exist: key switch 100 is turned off (step 202), battery power is disconnected (step 204), the control arm 2 is in a braking position (step 206), or the pallet truck 20 is in a non-low speed travel mode (208). If none of these conditions exist, then the coast control system 109 is activated (step 216) which causes the control arm 2 to become locked in a non-braking position (step 218), and the traction motor 110 to become engaged (step 220) while the pick button 108 is pressed (step 210). If the pick button 108 is released (step 222), the traction motor 110 de-actuates (step 224), and the motor controller 105 goes into a system check loop until the pick button 108 is again pressed (step 200), or any of the aforementioned conditions occur. If any of the aforementioned conditions occur, the coast control system 109 deactivates (step 212) and the truck exits the pick state. The control arm lock mechanism is released (step 214) and the control arm 2 moves to a substantially vertical position under power of the return spring 31 unless the operator applies force to retain the control arm 2 in a non-braking position.

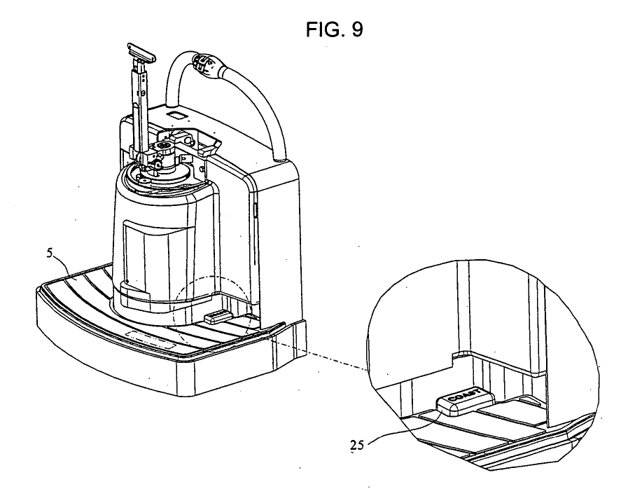

In an embodiment of this invention, a coast control enable button 25 shown in FIG. 9 is mounted to the operator platform 5. The operator first enables the coast control system by depressing the coast control enable button 25, and is then able to accelerate the pallet truck 20 in the pick state by means of the throttle 107 or pick button 108. In one embodiment, the coast control enable button 25 activates the coast control system 109 but does not actuate the traction motor when it is initially pressed. Pressing the coast control enable button 25 a second time could be set to either actuate the traction motor 110, or deactivate the coast control system 109.

Coast control enable button 25 can be made to simultaneously actuate the traction motor 110, and provide for subsequent actuation of the traction motor after the coast control system 109 has been activated. In this case, coast control enable button 25 would operate the same in all respects as the pick button 108, other than its location, and as described previously. Alternatively, pressing the coast control enable button 25 could alternate between activating and deactivating the coast control system. If the coast control enable button 25 actuates the traction motor 110, then the traction motor 110 could be actuated upon the first instance of the coast control enable button 25 being pressed, and each successive time the coast control enable button 25 is pressed.

An alternative embodiment provides for a coast control enable button 25 as shown in FIG. 9, mounted to the operator platform 5 whereby the operator first enables the coast control system by depressing the coast control enable button 25, and is then able to accelerate the pallet truck 20 in the pick state by means of the throttle 107 or pick button 108. The coast control enable button 25 could serve to activate the coast control system 109 but not actuate the traction motor when it is initially pressed. Pressing the coast control enable button 25 a second time could be set to either actuate the traction motor 110, or deactivate the coast control system 109. Coast control enable button 25 can be made to simultaneously actuate the traction motor 110, and provide for subsequent actuation of the traction motor after the coast control system 109 has been activated. In this case, coast control enable button 25 would operate the same in all respects as the pick button 108, other than its location, and as described in this patent. If the coast control enable button 25 does not actuate the traction motor 110 then pressing the coast control enable button 25 could alternate between activating and deactivating the coast control system. If the coast control enable button 25 actuates the traction motor 110, then the traction motor 110 could be actuated upon the first instance of the coast control enable button 25 being pressed, and each successive time the coast control enable button 25 is pressed.

The system thus described is furthermore compatible with a “creep speed” function whereby the operator is able to over-ride the braking condition of the pallet truck 20 with the control arm 2 in a vertical position, and cause the pallet truck 2 to move in reduced, or creep, speed. By overriding the braking condition with the control arm in a vertical, or near vertical position, the pallet truck 20 can be made to maneuver in a narrow turning radius or avoid getting stuck. In one embodiment, the creep speed would allow for a maximum vehicle travel speed that is less than the maximum travel speed allowed by the low speed travel mode previously described. One embodiment of this invention provides for the creep speed function to enable the pallet truck 20 to maneuver in small confines at a controlled low rate of travel, when the control arm 2 is located in an approximate vertical position V, for example, or in the pivot range Y1 shown in FIG. 6. Other embodiments may continue to provide for creep speed functionality when the steer arm is within the pivot range Y2, for example.

In a preferred embodiment, the creep speed function is disabled when the steer arm 2 is located in a horizontal position H or in the pivot range Y3, and instead the vehicle braking system would override the creep speed function and bring the pallet truck 20 to a controlled stop. Disabling the creep speed function in the pivot range Y3 would provide the operator an immediate means of braking the pallet truck 20. Furthermore, operation of the creep speed function with the steer arm 2 in the horizontal, or near horizontal position is not consistent with the goal of maneuvering the pallet truck 20 in a narrow confine at the reduced travel speed. With the steer arm 2 in the pivot range Y3, the turning radius of the pallet truck 20 is greatly increased as compared to the steer arm 2 being in a pivot range Y1, for example. The operator who is carefully maneuvering the pallet truck 20 in a narrow confine, would want to reduce the turning radius in order to avoid hitting obstacles.

A creep speed button may be included in the vicinity of the steer control handle 13, for example, which would engage a creep speed mode of the motor controller 105. The creep speed mode may be engaged upon a single press of the creep speed button, or alternatively be engaged only as long as the button is continually held in a pressed condition. Other types of switches, levers or controls may be used instead of the creep speed button, including being located on different parts of the steer arm 2 or on other locations of the pallet truck 20.

Other components, methods, and systems of the pallet truck 20 that are not described in this patent are understood to operate in a similar manner to other conventional pallet trucks known in the existing art. The system and apparatus described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or diagrams. This is not necessary, however, and there may be cases where these functional blocks or diagrams are equivalently aggregated into a single logic device, program or operation with unclear boundaries.

Having described and illustrated the principles of the invention in a preferred embodiment thereof, it should be apparent that the invention may be modified in arrangement and detail without departing from such principles. I claim all modifications and variation coming within the spirit and scope of the following claims.

1. An apparatus for controlling a motorized lift truck having a vehicle frame, comprising:
a coast control;
a steer arm; and
an actuation cylinder attached to the steer arm that locks the steer arm in an operator selectable position when the coast control is activated.

2. The apparatus according to claim 1 wherein the coast control is located on a floor of the motorized vehicle.

3. The apparatus according to claim 1 wherein the actuation cylinder is attached externally to the steer arm and to the vehicle frame.

4. The apparatus according to claim 3 wherein one end of the actuation cylinder includes a rod attached adjacent to a handle on the steer arm.

5. The apparatus according to claim 1 wherein a hydraulic pressure accumulates in the actuation cylinder when the coast control is activated.

6. The apparatus according to claim 5 wherein a hydraulic pressure is released from the actuation cylinder when the steer arm is moved out of the operator selectable position or when the coast control is deactivated.

7. The apparatus according to claim 6 including a return spring that urges the steer arm to a braking position when the hydraulic pressure is released.

8. A hydraulic system for controlling operation of a pallet truck having a steer arm pivotally attached, comprising:
a hydraulic reservoir;
a hydraulic valve; and
a hydraulic cylinder, wherein the hydraulic valve directs a hydraulic pressure between the hydraulic reservoir and the hydraulic cylinder in order to control a position of the steer arm.

9. The hydraulic system according to claim 8 wherein the steer arm is held in a user selected position when the hydraulic pressure is directed to the hydraulic cylinder.

10. The hydraulic system according to claim 9 wherein the hydraulic cylinder overcomes a spring force of a return spring to hold the steer arm in the user selected position.

11. The hydraulic system according to claim 8 including a return spring that urges the steer arm to a braking position when the hydraulic pressure is directed to the hydraulic reservoir.

12. The hydraulic system according to claim 8 including a coast control system that instructs the hydraulic valve to direct the hydraulic pressure to the hydraulic cylinder.

13. The hydraulic system according to claim 12 wherein the hydraulic pressure is directed to the hydraulic reservoir when the coast control system is deactivated or the steer arm is forced out of a locked position.

14. A method for operating an industrial lift truck having a tiller arm, comprising:
lowering the tiller arm to a non-vertical user selected position;
activating a coast control; and
increasing a hydraulic pressure in a hydraulic cylinder to hold the tiller arm in the user selected position.

15. The method according to claim 14 including activating a hydraulic valve to control the hydraulic pressure in the hydraulic cylinder.

16. The method according to claim 14 including moving the tiller arm out of the user selected position and decreasing the hydraulic pressure in the hydraulic cylinder.

17. The method according to claim 16 including urging the tiller arm to a vertical position and braking the industrial pallet truck.

18. The method according to claim 17 wherein a return spring internal to the tiller arm urges the tiller arm to the vertical position.

19. The method according to claim 14 including deactivating the coast control and decreasing the hydraulic pressure in the hydraulic cylinder.

20. The method according to claim 19 including simultaneously increasing the hydraulic pressure in a hydraulic reservoir.
